(19) United States
(12) Patent Application Publication
(10) Pub. No.: US 2023/0039113 A1
(43) Pub. Date: Feb. 9, 2023

(54) HYBRID DATABASE FOR TRANSACTIONAL AND ANALYTICAL WORKLOADS

(71) Applicant: VMware, Inc., Palo Alto, CA (US)

(72) Inventors: Zhenghua Lyu, Beijing (CN); Huan Zhang, Beijing (CN); Haozhou Wang, Beijing (CN); Gang Guo, Beijing (CN); Jinbao Chen, Burnaby (CA); Yu Yang, Beijing (CN); Xiaoming Gao, Beijing (CN); Ashwin Agrawal, Sunnyvale, CA (US); Wen Lin, Beijing (CN); Junfeng Yang, Beijing (CN); Hao Wu, Qingdao (CN); Xiaoliang Li, Beijing (CN); Feng Guo, Beijing (CN); Jiang Wu, Beijing (CN); Jesse Zhang, San Mateo, CA (US)

(21) Appl. No.: 17/499,724

(22) Filed: Oct. 12, 2021

(30) Foreign Application Priority Data
Jul. 27, 2021 (CN) PCT/CN2021/108539

(51) Int. Cl. G06F 16/23; G06F 9/52; G06F 16/901

(52) U.S. Cl. CPC G06F 16/2379; G06F 9/524; G06F 16/2343; G06F 16/9024

(57) ABSTRACT

A computer-implemented method, medium, and system for global deadlock detection in a hybrid database for transactional and analytical workloads are disclosed. In one computer-implemented method, a daemon is launched on a coordinator segment in a massively parallel processing (MPP) database, where the MPP database is a hybrid database for both transactional workloads and analytical workloads. A respective local wait-for graph for each of a plurality of segments in the MPP database is collected periodically, where each of the plurality of segments includes the coordinator segment or a worker segment of a plurality of worker segments in the MPP database. A global wait-for graph that includes all collected local wait-for graphs is built. The global wait-for graph is used to determine that a global deadlock exists in the MPP database. The global deadlock is broken using one or more predefined policies in response to determining that the global deadlock exists.

### TECHNICAL FIELD

The present disclosure relates to computer-implemented methods, medium, and systems for hybrid database for transactional and analytical workloads.

### BACKGROUND

Some large scale data-warehouse systems have both enterprise and open-source deployments. The massively parallel processing (MPP) architecture of some large scale data-warehouse systems can split the data into disjoint parts that are stored across individual worker segments. Such MPP systems are able to efficiently manage and query petabytes of data in a distributed fashion. In contrast, distributed relational databases have focused on providing a scalable solution for storing terabytes of data and fast processing of transactional queries.

Users of some MPP systems can interact with the system through a coordinator, and the underlying distributed architecture is transparent to the users. For a given query, the coordinator optimizes it for parallel processing and dispatches the generated plan to the segments. Each segment executes the plan in parallel, and when needed shuffles tuples among segments. This approach can achieve significant speedup for long running analytical queries. Results are gathered by the coordinator and are then relayed to clients. Data Manipulation Language (DML) based operations can be used to modify data hosted in the worker segments. Atomicity can be ensured via a two-phase commit protocol. Concurrent transactions are isolated from each other using distributed snapshots. Some MPP systems can support append-optimized column-oriented tables with a variety of compression algorithms. These tables are well suited for bulk write and read operations which are typical in Online Analytical Processing (OLAP) workloads.

Some MPP systems were designed with OLAP queries as the primary focus while OLTP workloads were not the primary focus. The two-phase commit protocol poses a performance penalty for transactions that update only a few tuples. Heavy locking imposed by the coordinator, intended to prevent distributed deadlocks, can be overly restrictive. This penalty disproportionately affects short running queries. It may be desirable to have a single system that can cater to both OLAP and Online Transaction Processing (OLTP) workloads.

### SUMMARY

The present disclosure involves computer-implemented methods, medium, and systems for global deadlock detection in a hybrid database for transactional and analytical workloads. One example method includes launching a daemon on a coordinator segment in a massively parallel processing (MPP) database, where the MPP database includes the coordinator segment and a plurality of worker segments, the MPP database is a hybrid database for both transactional workloads and analytical workloads, and the transactional workloads are associated with transactions with each transaction modifying two or more entities in the MPP database. A respective local wait-for graph for each of a plurality of segments in the MPP database is collected periodically, where each of the plurality of segments includes the coordinator segment or a worker segment of the plurality of worker segments in the MPP database, each collected local wait-for graph includes a plurality of local vertices representing transactions associated with a respective segment and a plurality of local edges that go between the plurality of local vertices, and each of the plurality of segments in the MPP database includes transactions that are waiting for other transactions to commit or abort. A global wait-for graph that includes all collected local wait-for graphs is built, where the global wait-for graph includes a plurality of vertices and a plurality of edges that go between the plurality of vertices. The global wait-for graph is used to determine that a global deadlock exists in the MPP database, where the global deadlock exists when each transaction in the MPP database is waiting for another transaction in the MPP database to commit or abort. The global deadlock is broken using one or more predefined policies in response to determining that the global deadlock exists.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an example system that can execute implementations of the present disclosure.

FIG. 2 is a schematic illustration of example computer systems that can be used to execute implementations of the present disclosure.

FIG. 3 illustrates an example data processing workflow, in accordance with example implementations of this specification.

FIG. 4 illustrates an example architecture of an MPP database, in accordance with example implementations of this specification.

FIG. 5 illustrates an example distributed plan that is compiled from a join Structured Query Language (SQL) query, in accordance with example implementations of this specification.

FIG. 6 illustrates an example SALES table partitioned by sale date with each partition defined by a date range, in accordance with example implementations of this specification.

FIG. 7 is a flowchart illustrating an example global deadlock case in an MPP database, in accordance with example implementations of this specification.

FIG. 8 is a flowchart illustrating an example global deadlock case in an MPP database, in accordance with example implementations of this specification.

FIG. 9 is a flowchart illustrating an example of a method for detecting global deadlock in an MPP database, in accordance with example implementations of this specification.

FIG. 10 is a flowchart illustrating an example of a method for implementing step 908 in FIG. 9, i.e., for determining that the global deadlock exists in the MPP database by utilizing the global wait-for graph, in accordance with example implementations of this specification.

FIG. 11 is a flowchart illustrating an example global deadlock detection (GDD) algorithm, in accordance with example implementations of this specification.

FIG. 12 is a flowchart illustrating an example non-deadlock case in an MPP database, in accordance with example implementations of this specification.

FIG. 13 is a flowchart illustrating an example process of GDD algorithm execution used to determine that the case illustrated in FIG. 12 has no global deadlock, in accordance with example implementations of this specification.

FIG. 14 is a flowchart illustrating an example non-deadlock case in an MPP database, in accordance with example implementations of this specification.

FIG. 15 is a flowchart illustrating an example process of GDD algorithm execution used to determine that the case illustrated in FIG. 14 has no global deadlock, in accordance with example implementations of this specification.

FIG. 16 is a flowchart illustrating an example of a method for memory isolation in an MPP database, in accordance with example implementations of this specification.

### DETAILED DESCRIPTION

A hybrid transactional and analytical processing (HTAP) database brings several benefits when compared with an OLAP or OLTP database. First, HTAP databases can reduce the wait time of new data analysis tasks significantly, as there is no extract, transform, and load (ETL) transferring delay. It can lead to real-time data analysis without extra components or external systems. Second, HTAP databases can reduce the overall business cost in terms of hardware and administration. Some MPP based data warehouse systems (also called MPP databases) that were originally designed for handling OLAP workloads can be augmented into a hybrid system to serve both OLTP and OLAP workloads.

This specification describes technologies for global deadlock detection and memory isolation in a hybrid HTAP database. In some implementations, local and global wait-for graphs can be constructed to help determine whether global deadlock exists in the hybrid HTAP database. In some implementations, different memory layers can be created to manage memory usage and to determine whether a particular query should be removed in order to alleviate performance degradation caused by memory resource competition in a highly concurrent, mixed workload environment.

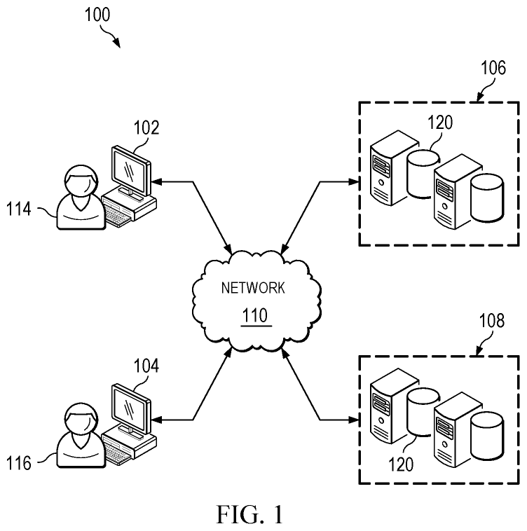

FIG. 1 depicts an example system 100 that can execute implementations of the present disclosure. In the depicted example, the example system 100 includes a client device 102, a client device 104, a network 110, and a cloud environment 106 and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the cloud environment 106 include at least one server and at least one data store 120. In the example of FIG. 1, the cloud environment 106 is intended to represent various forms of servers including, but not limited to, a web server, an application server, a proxy server, a network server, and/or a server pool. In general, server systems accept requests for application services and provides such services to any number of client devices (e.g., the client device 102 over the network 110).

In accordance with implementations of the present disclosure, and as noted above, the cloud environment 106 can host applications and databases running on host infrastructure. In some instances, the cloud environment 106 can include multiple cluster nodes that can represent physical or virtual machines. A hosted application and/or service can run on VMs hosted on cloud infrastructure. In some instances, one application and/or service can run as multiple application instances on multiple corresponding VMs, where each instance is running on a corresponding VM.

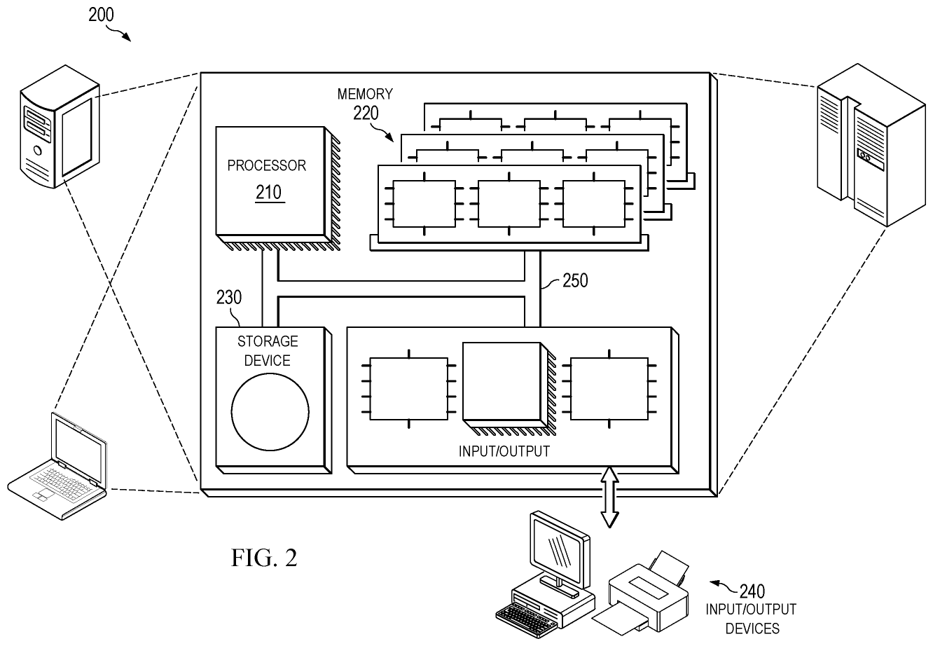

Referring now to FIG. 2, a schematic diagram of an example computing system 600 is provided. The system 200 can be used for the operations described in association with the implementations described herein. For example, the system 200 may be included in any or all of the server components discussed herein. The system 200 includes a processor 210, a memory 220, a storage device 230, and an input/output device 240. The components 210, 220, 230, and 240 are interconnected using a system bus 250. The processor 210 is capable of processing instructions for execution within the system 200. In some implementations, the processor 210 is a single-threaded processor. In some implementations, the processor 210 is a multi-threaded processor. The processor 210 is capable of processing instructions stored in the memory 220 or on the storage device 230 to display graphical information for a user interface on the input/output device 240.

The memory 220 stores information within the system 200. In some implementations, the memory 220 is a computer-readable medium. In some implementations, the memory 220 is a volatile memory unit. In some implementations, the memory 220 is a non-volatile memory unit. The storage device 230 is capable of providing mass storage for the system 200. In some implementations, the storage device 230 is a computer-readable medium. In some implementations, the storage device 230 may be a floppy disk device, a hard disk device, an optical disk device, or a tape device. The input/output device 240 provides input/output operations for the system 200. In some implementations, the input/output device 240 includes a keyboard and/or pointing device. In some implementations, the input/output device 240 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

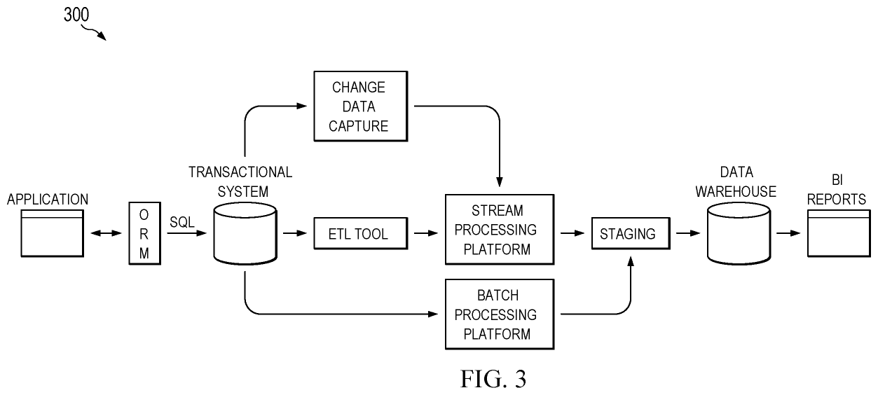

FIG. 3 illustrates example data processing workflow, in accordance with example implementations of this specification. The workflow involves operational databases managing transactional data for a short period of time. This data is then periodically transformed, using Extract Transform and Load (ETL) tools, and loaded into a data warehouse for further analysis. It would be desirable to reduce the complexity of maintaining disparate systems. Users may prefer having a single system that can handle both OLAP and OLTP workloads. In other words, such a system needs to be highly responsive for point queries as well as scalable for long running analytical queries.

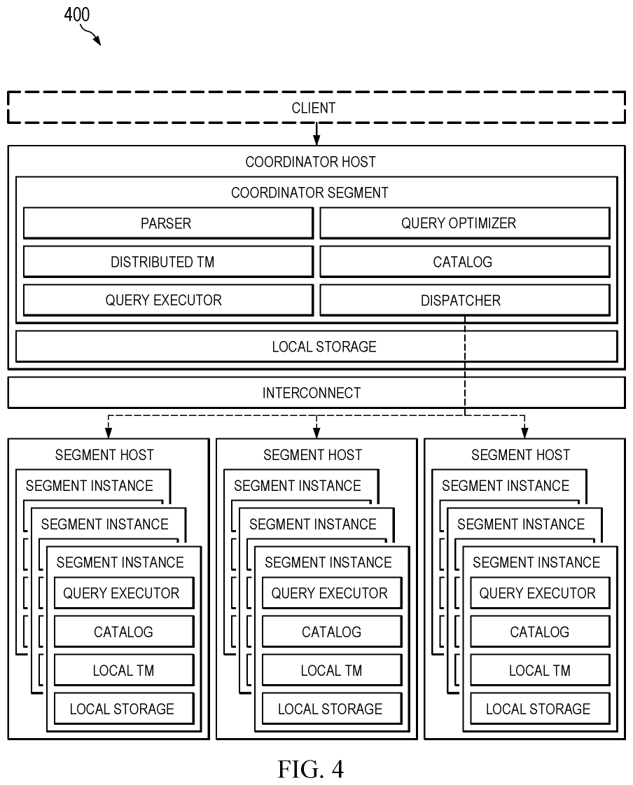

FIG. 4 illustrates example architecture of an MPP database, in accordance with example implementations of this specification. The architecture includes a database cluster based on an MPP architecture. An example running database cluster can consist of multiple running worker segments with each being an enhanced PostgreSQL.

In some implementations, a database cluster can include many segments across many hosts. In some implementations, there is only one segment called the coordinator segment in the entire database system, and the other segments are called worker segments. The coordinator segment is directly connected to user clients. In some implementations, the coordinator segment receives commands or queries from the user clients, generates a distributed query plan, spawns distributed processes according to the plan, dispatches it to each process, gathers the results, and finally sends the results back to the clients. In some implementations, worker segments serve as the primary storage of user data and each one of the worker segments executes a specific part of a distributed plan from the coordinator segment. In some implementations, to achieve high availability, some worker segments are configured as mirrors or standbys for the coordinator segment. Mirrors and standbys will not participate in computing directly. Instead, they receive write-ahead logging (WAL) logs from their corresponding primary segments continuously and replay the logs on the fly. In some implementations, the coordinator segment and the worker segments have their own shared memory and data directory. In some implementations, the coordinator segment communicates with the worker segments through networks.

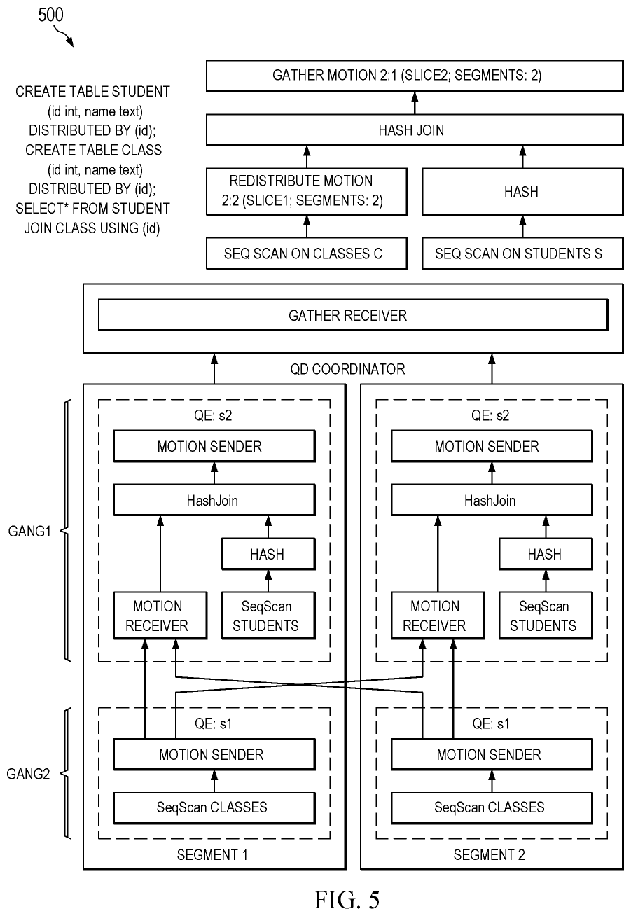

FIG. 5 illustrates an example distributed plan that is compiled from a join Structured Query Language (SQL) query, in accordance with example implementations of this specification.

In some implementations, for a distributed relation, each worker segment only stores a small portion of the whole data. When joining two relations, one often needs to check if two tuples from different segments match the join condition. This means that the database must move data among segments to make sure that all possible matching tuples are in the same segment. In some implementations, a motion plan node can be used to implement such data movement.

In some implementations, a motion plan node uses networks to send and receive data from different segments (hosts). In some implementations, motion plan nodes can cut the plan into pieces, each piece below or above the Motion is called a slice. In some implementations, each slice is executed by a group of distributed processes, and the group of processes is called gang. With the motion plan nodes and the gangs, the database's query plan and the executor both becomes distributed. In some implementations, the plan can be dispatched to each process, and based on its local context and state, each process executes its own slice of the plan to finish the query execution. In some implementations, the same plan is dispatched to groups of processes across the cluster and different processes spawned by different segments have their own local context, states, and data.

As illustrated in FIG. 5, the execution progress of the example distributed plan is in a cluster with two segments. The top slice is executed by a single process on the coordinator segment, and other slices are executed on worker segments. One slice scans the table and then sends the tuples out using redistributed motion. Another slice that performs hash join will receive tuples from the motion node, scan the student table, build a hash table, compute the hash join, and finally send tuples out to the top slice.

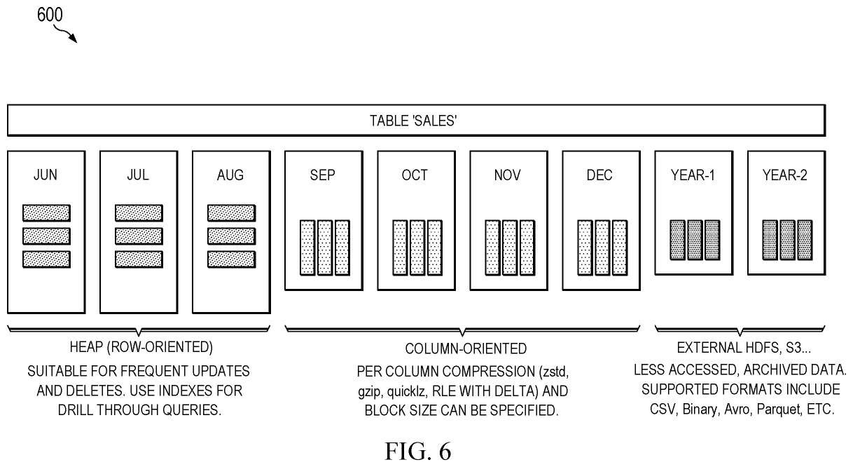

FIG. 6 illustrates an example SALES table partitioned by sale date with each partition defined by a date range, in accordance with an implementation of this solution.

In some implementations, an MPP database can support PostgreSQL native heap tables, which is a row oriented storage having fixed sized blocks and a buffer cache shared by query executing processes running on a segment to facilitate concurrent read and write operations. In some implementations, an MPP database can include two table types: append-optimized row oriented storage (AO-row) and append-optimized column oriented storage (AO-column). In some implementations, AO tables favor bulk I/O over random access making them more suitable for analytic workloads. In some implementations, in AO-column tables, each column is allotted a separate file. This design can reduce input/output (I/O) for queries that select only a few columns from a wide table. In some implementations, AO tables can be compressed with a variety of algorithms, such as zstd, quicklz and zlib. In some implementations, in an AO-column table, each column can be compressed using a specific algorithm, including run-length-encoding (RLE) with delta compression. In some implementations, the query execution engine in the MPP database can be agnostic to table storage type. In some implementations, AO-row, AO-column and heap tables can be joined in the same query.

In some implementations, a table can be partitioned by user-specified key and partition strategy (list or range). In some implementations, this can implemented by creating a hierarchy of tables underneath a root table, with only the leaf tables containing user data. In some implementations, a partitioning feature with similar design can be adopted later by upstream PostgreSQL. In some implementations, each partition within a hierarchy can be a heap, AO-row, AO-column or an external table. In some implementations, external tables are used to read/write data that is stored outside the MPP database.

As illustrated in FIG. 6, recent partitions are created as native heap tables (June-August). AO-column storage is used for slightly older sales data (September-December) while prior years' sales data is archived in external tables. Queries can be made against SALES table or its individual partitions without being aware of the table's storage.

In some implementations, query optimization can be flexible. In some implementations, query optimization can be workload dependent. In some implementations, analytical workloads are composed of ad-hoc and complex queries involving many joins and aggregates. In some implementations, query performance is mainly determined by the efficiency of the query plan. In some implementations, a query optimizer in an MPP database can be a cost-based optimizer designed for analytical workloads. On the other hand, in some implementations, transactional workloads can include short queries, which are sensitive to query planning latency. In some implementations, an optimizer need to generate a simple plan quickly. In some implementations, users can choose at the query, session, or database level between a cost-based optimizer and an optimizer for quick generation of simply plans. In some implementations, this can help the MPP database to handle HTAP workloads more efficiently.

In some implementations, locks are used in an MPP database to prevent race conditions at different levels of granularity. In some implementations, there are three different kinds of locks designed for different use cases in an MPP database: spin locks, LWlocks and object locks. In some implementations, spin locks and LWlocks are used to protect the critical region when reading or writing shared memories, and by following some rules (e.g. to acquire locks in the same order) deadlocks involving these two kinds of locks can be removed. In some implementations, object locks directly impact the concurrency of processes when operating on database objects such as relations, tuples, or transactions.

In some implementations, some objects such as relations, can be concurrently manipulated by transactions. In some implementations, when accessing such an object, locks can be held in a correct mode to protect the object. In some implementations, an MPP database adopts two-phase locking: locks are held in the first phase, and released when transactions are committed or aborted. In some implementations, there are eight different levels of lock modes in an MPP database. In some implementations, higher levels of lock modes enable stricter granularity of concurrency control. The lock modes, their conflict modes and the corresponding typical statements are shown in Table 1. If the lock level of DML operation is increased to make sure that the transaction is running serially to avoid deadlock issues, performance in multi-transactions may be poor as only one transaction updating or deleting on the same relation could be processed at one time.

TABLE 1

| | | Conflict | Typical |
|---|---|---|---|
| Lock Mode | Level | lock level | Statements |
| AccessShareLock | 1 | 8 | Pure select |
| RowShareLock | 2 | 7, 8 | Select for |
| | | | update |
| RowExclusiveLock | 3 | 5, 6, 7, 8 | Insert |
| ShareUpdateExclusiveLock | 4 | 4, 5, 6, 7, 8 | Vaccum |
| | | | (not full) |
| ShareLock | 5 | 3, 4, 6, 7, 8 | Create index |
| ShareRowExlcusiveLock | 6 | 3, 4, 5, 6, 7, 8 | Collation |
| | | | create |
| ExclusiveLock | 7 | 2, 3, 4, 5, 6, 7, 8 | Concurrent |
| | | | refresh |
| | | | matview |
| AccessExclusiveLock | 8 | 1, 2, 3, 4, 5, 6, 7, 8 | Alter table |

For example, most alter table statements can change the catalog and affect optimizer to generate a plan, so these alter table statements may not be allowed to be concurrently running with other statements operating on the same relation. According to Table 1, alter table statements will hold AccessExclusive lock on the relation. AccessExclusive is the highest lock level and it can conflict with all lock levels.

In some implementations, the MPP database is a distributed system, and lock level of INSERT, DELETE and UPDATE DML statements is associated with the handling of global deadlocks. In some implementations, the locking behavior of these DML statements is as follows:

First, during the parse-analyze stage, a computer system, for example, one in the cloud environment 106 of FIG. 1 that executes the transaction, locks the target relation in some mode.

Second, during the execution, the computer system that executes the transaction writes its identifier into the tuple. This is a way of locking tuple using the transaction lock.

In a single-segment database such as PostgreSQL, the first stage often locks the target relation in RowExclusive mode, so that they can run concurrently. Only if two transactions happen to write (UPDATE or DELETE) the same tuple, one will wait on the tuple's transaction lock until the other one is committed or aborted. The lock dependencies can be stored in the shared memory of each segment instance. If a deadlock happens, one can scan the lock information in shared memory in order to break the deadlock.

In some implementations, the aforementioned approach for a single-segment database may not be sufficient in an MPP database that has distributed architecture. In some implementations, even if each segment in an MPP database cluster is an enhanced PostgreSQL instance with the local deadlock handler, the MPP database may not be able to avoid a global deadlock if the waiting behavior happens across different segments.

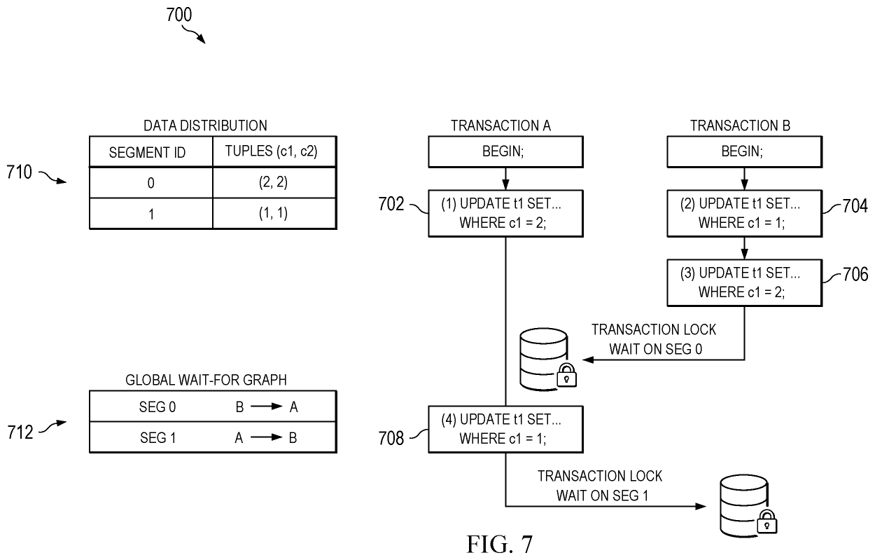

FIG. 7 illustrates an example global deadlock case in an MPP database, in accordance with example implementations of this specification.

At 702, a computer system that executes transaction A updates a tuple that is stored in segment 0, holding a transaction lock on segment 0.

At 704, a computer system that executes transaction B updates a tuple that is stored in segment 1, holding a transaction lock on segment 1. Until now, everything works well, no waiting event happens.

At 706, the computer system that executes transaction B updates the same tuple that just has been updated by transaction A on segment 0, because transaction A has not committed or aborted yet, transaction B has to wait. Transaction A is working normally and waiting for the next statement.

At 708, the computer system that executes transaction A updates the tuple on segment 1 that is locked by transaction B, therefore it also has to wait.

Now, on segment 0, transaction B is waiting for transaction A; on segment 1, transaction A is waiting for transaction B. Neither of them can go one step further and every PostgreSQL instance has no local deadlock. This results in a global deadlock.

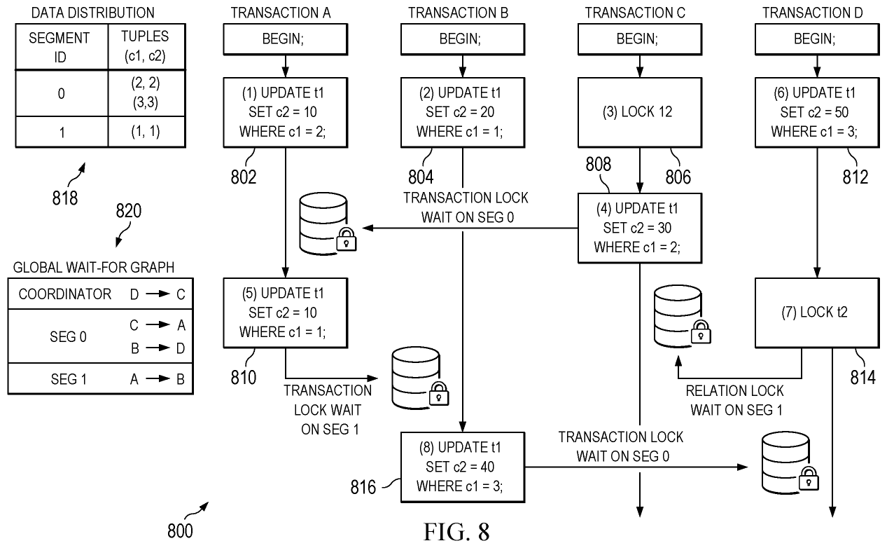

FIG. 8 illustrates an example global deadlock case in an MPP database, in accordance with example implementations of this specification.

At 802, a computer system that executes transaction A locks the tuple in relation t1 with c1=2 on segment 0 by the UPDATE statement.

At 804, a computer system that executes transaction B locks the tuple in relation t1 with c1=1 on segment 1 by the UPDATE statement.

At 806, a computer system that executes transaction C locks relation t2 on coordinator and all segments by the LOCK statement.

At 808, the computer system that executes transaction C attempts to acquire the lock of tuple in relation t1 with c1=2 on segment 0, which is already locked by transaction A, so transaction C waits.

At 810, the computer system that executes transaction A tries to lock the tuple in relation t1 with c1=1 on segment 1, which is already locked by transaction B, so transaction A waits.

At 812, a computer system that executes transaction D locks the tuple in relation t1 with c1=3 on segment 0 by UPDATE statement.

At 814, the computer system that executes transaction D continues to try to lock the relation t2 on coordinator by LOCK statement, it will wait because transaction C holds the lock on t2.

At 816, the computer system that executes transaction B continues to try to lock the tuple in relation t1 with c1=3 on segment 0 which is locked by transaction D and it also waits.

Now, on segment 1, transaction A is waiting for transaction B; on segment 0, transaction B is waiting for transaction D; on coordinator, transaction D is waiting for transaction C; on segment 0, transaction C is waiting for transaction A. Therefore a global deadlock occurs.

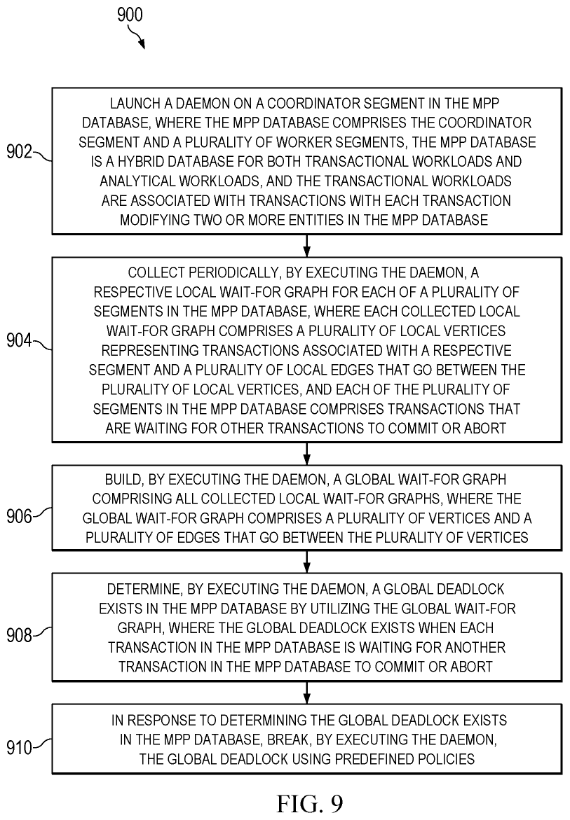

FIG. 9 illustrates an example of a method for detecting global deadlock in an MPP database, in accordance with example implementations of this specification. It will be understood that method 900 and related methods may be performed, for example, by any suitable system, environment, software, and hardware, or a combination of systems, environments, software, and hardware, as appropriate. For example, one or more of a client, a server, or other computing device can be used to execute method 900 and related methods and obtain any data from the memory of a client, the server, or the other computing device. In some instances, the method 900 and related methods are executed by one or more components of the system 100 described above with respect to FIG. 1. For example, the method 900 and related methods can be executed by the cloud environment 106 of FIG. 1.

At 902, an MPP database, for example, one implemented on cloud environments 106 and 108 in FIG. 1, launches a daemon on a coordinator segment in the MPP database, where the MPP database comprises the coordinator segment and a plurality of worker segments, the MPP database is a hybrid database for both transactional workloads and analytical workloads, and the transactional workloads are associated with transactions with each transaction modifying two or more entities in the MPP database.

At 904, the MPP database collects periodically, by executing the daemon, a respective local wait-for graph for each of a plurality of segments in the MPP database, where each of the plurality of segments can be either the coordinator segment or a worker segment of the plurality of worker segments, where each collected local wait-for graph comprises a plurality of local vertices representing transactions associated with a respective segment and a plurality of local edges that go between the plurality of local vertices, and each of the plurality of segments in the MPP database comprises transactions that are waiting for other transactions to commit or abort.

At 906, the MPP database builds, by executing the daemon, a global wait-for graph comprising all collected local wait-for graphs, where the global wait-for graph comprises a plurality of vertices and a plurality of edges that go between the plurality of vertices.

At 908, the MPP database determines, by executing the daemon, that a global deadlock exists in the MPP database by utilizing the global wait-for graph, wherein the global deadlock exists when each transaction in the MPP database is waiting for another transaction in the MPP database to commit or abort.

At 910, in response to determining the global deadlock exists in the MPP database, the MPP database breaks, by executing the daemon, the global deadlock using one or more predefined policies.

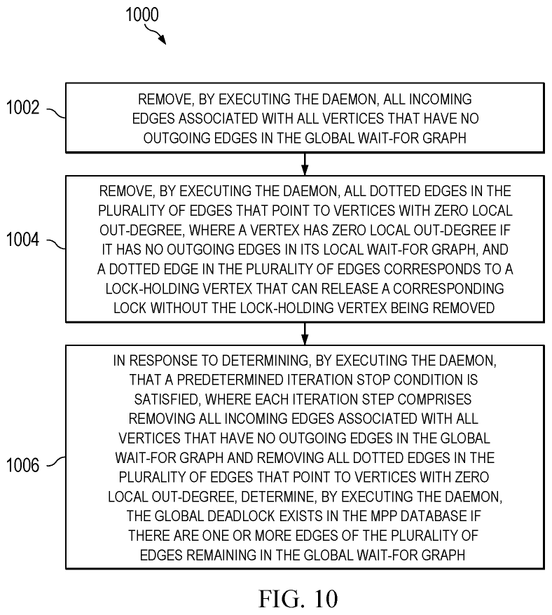

FIG. 10 illustrates an example of a method for implementing step 908 in FIG. 9, i.e., for determining that the global deadlock exists in the MPP database by utilizing the global wait-for graph, in accordance with example implementations of this specification. It will be understood that method 1000 and related methods may be performed, for example, by any suitable system, environment, software, and hardware, or a combination of systems, environments, software, and hardware, as appropriate. For example, one or more of a client, a server, or other computing device can be used to execute method 1000 and related methods and obtain any data from the memory of a client, the server, or the other computing device. In some implementations, the method 1000 and related methods are executed by one or more components of the system 100 described above with respect to FIG. 1. For example, the method 1000 and related methods can be executed by the cloud environment 106 of FIG. 1.

At 1002, the MPP database removes, by executing the daemon, all incoming edges associated with all vertices that have no outgoing edges in the global wait-for graph.

At 1004, the MPP database removes, by executing the daemon, all dotted edges in the plurality of edges that point to vertices with zero local out-degree, where a vertex has zero local out-degree if it has no outgoing edges in its local wait-for graph, and a dotted edge in the plurality of edges corresponds to a lock-holding vertex that can release a corresponding lock without the lock-holding vertex being removed.

At 1006, in response to determining, by executing the daemon, that a predetermined iteration stop condition is satisfied, where each iteration step comprises removing all incoming edges associated with all vertices that have no outgoing edges in the global wait-for graph and removing all dotted edges in the plurality of edges that point to vertices with zero local out-degree, the MPP database determines, by executing the daemon, the global deadlock exists in the MPP database if there are one or more edges of the plurality of edges remaining in the global wait-for graph.

The implementations described below illustrate how a global deadlock detection (GDD) algorithm can be used to detect global deadlock in an MPP database.

In some implementations, the GDD algorithm has the following workflow: First, the MPP database launches a daemon on the coordinator segment. Second, the daemon periodically collects wait-for graphs on each segment. Third, the daemon checks if a global deadlock happens. Finally, the daemon breaks the global deadlock using predefined policies such as terminating the youngest transaction.

In some implementations, the daemon collects each segment's local wait-for graph (including the coordinator's) and builds a global wait-for graph. It is a set of local wait-for directed graphs, where each vertex represents a transaction, and the edge is starting from the waiting transaction to the holding transaction. For each vertex which represents a transaction, the number of its outgoing edges is the out-degree of the vertex, and the number of its incoming edges is the in-degree of the vertex. The local degree of a vertex is the value counting only in a single segment's wait-for graph. The global degree of a vertex is the value summing all local degrees of all segments.

In some implementations, the term deg^{(G)}(V) is used to denote the global out-degree of the vertex V, degᵢ(V) is used to denote the local out-degree of vertex V in segment i. For example, in FIG. 8, deg^{(G)}(V)=1 since there is one edge from C to D in segment 0, and deg₋₁(C)=0 since there is no outgoing edge from C in segment −1.

In some implementations, the waiting information collected from each segment is asynchronous, and when analyzing the information in the coordinator, the delay is considered. The GDD algorithm includes greedy rules that keep removing waiting edges that might continue running later. When no more waiting edges can be removed, if there still exist waiting edges, then global deadlock might happen. In that case, the detector daemon will lock all processes in the coordinator to check whether all the remaining edges are still valid. If some transactions have been finished (either aborted or committed), the daemon discards all the information associated with those transactions, invokes sleep, and continues the global deadlock detection job in the next run. The period to run the job is a configurable parameter for the MPP database to suit a variety of business requirements.

In some implementations, there are two different notations of waiting edges in the global wait-for graph:

Solid edge: the waiting disappears only after the lock-holding transaction ends (either being committed or aborted). A typical case is when a relation lock on the target table in UPDATE or DELETE statements. The lock can only be released at the end of the transaction ends. Such an edge can be removed only when the holding transaction is not blocked everywhere because based on the greedy rule we can suppose the hold transaction will be over and release all locks it holds.

Dotted edge: denotes a lock-holding transaction can release the lock even without ending the transaction. For example, a tuple lock that is held just before modifying the content of a tuple during the execution of a low level delete or update operation. Such an edge can be removed only when the holding transaction is not blocked by others in the specific segment. This is based on the greedy rule we can suppose the hold transaction will release the locks that blocks the waiting transaction without committing or aborting.

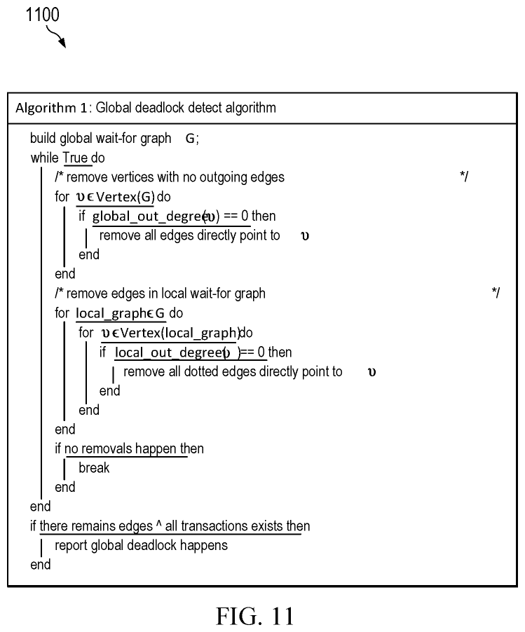

FIG. 11 illustrates an example GDD algorithm, in accordance with example implementations of this specification. In each loop, the GDD algorithm first removes all vertices with zero global out degree, then scans each local wait-for graph to remove all dotted edges that are pointing to a vertex with zero local out-degree. If the lock-holding transactions continue to execute, eventually they will release all the locks that they are holding.

For the deadlock case illustrated in FIG. 7, the wait-for graph shows that there is no vertex with zero global out-degree, so during the first round no edges are removed. The wait-for graph also shows that in each segment there is no dotted edges, therefore no edges are removed in the execution of the second round. Thus the wait-for graph is the final state and it contains a global cycle, which means global dead lock happens.

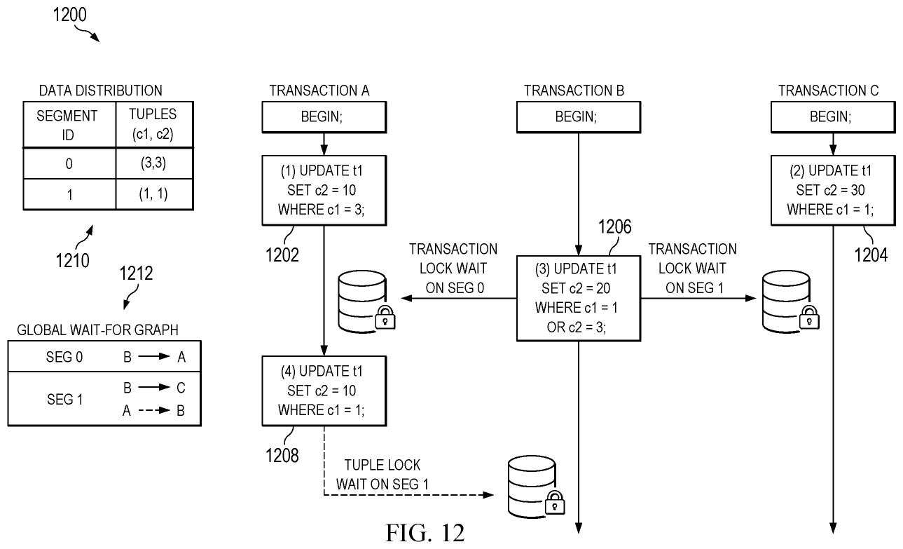

FIG. 12 illustrates an example non-deadlock case in an MPP database, in accordance with example implementations of this specification.

At 1202, a computer system that executes transaction A locks the tuple in relation t1 with c1=3 on segment 0 by the UPDATE statement.

At 1204, a computer system that executes transaction C locks the tuple in relation t1 with c1=1 on segment 1 by the UPDATE statement.

At 1206, a computer system that executes transaction B tries to lock the tuple in relation t1 with c1=1 or c1=3, it will be blocked by transaction A on segment 0 and by transaction C on segment 1.

At 1208, the computer system that executes transaction A tries to lock the tuple in relation t1 with c1=1 on segment 1, it will be blocked by a tuple lock held by transaction B on segment 1.

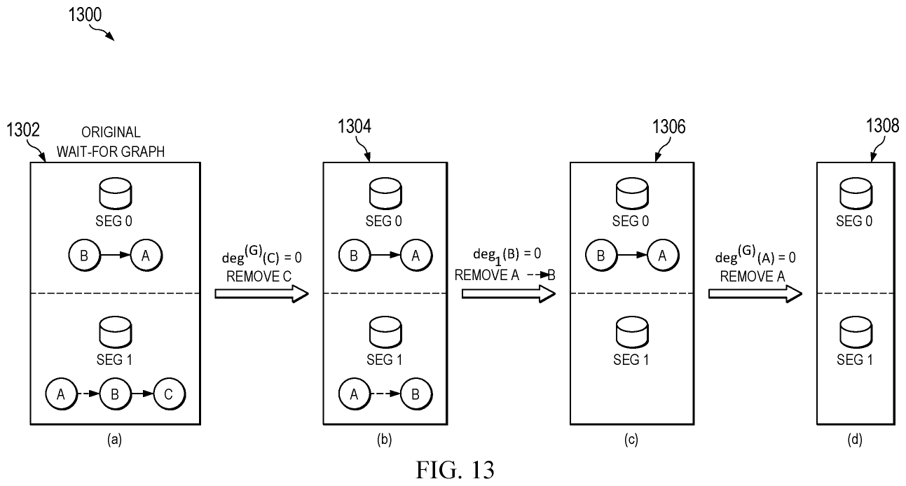

FIG. 13 illustrates an example process of GDD algorithm execution used to determine that the case illustrated in FIG. 12 has no global deadlock, in accordance with example implementations of this specification. This example process can be performed, for example, by an MPP database implemented on cloud environments 106 and 108 in FIG. 1.

At 1302, for the original global wait-for graph 1212 in FIG. 12, a computer system determines that deg^{(G)}(C)=0. Therefore vertex C and all the edges to C can be removed based on the GDD algorithm.

At 1304, the computer system determines that no vertex satisfies deg^{(G)}(v)=0. Next local out-degree is checked and the computer system determines that deg₁ (B)=0. Thus all the dotted edges to B on segment 1 can be removed based on the GDD algorithm.

At 1306, the computer system determines that deg^{(G)}(A)=0 for vertex A. Therefore all edges to A can be removed based on the GDD algorithm.

At 1308, no edges are left so the GDD algorithm will report no global deadlock for this case.

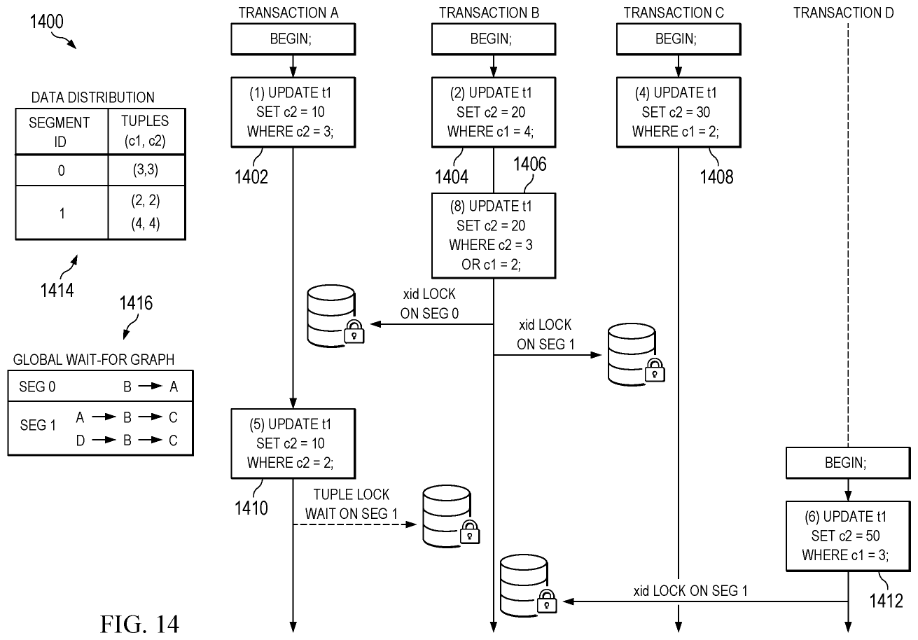

FIG. 14 illustrates an example non-deadlock case in an MPP database, in accordance with example implementations of this specification.

At 1402, a computer system that executes transaction A locks the tuple in relation t1 with c1=3 on segment 0 by the UPDATE statement.

At 1408, a computer system that executes transaction C locks the tuple in relation t1 with c1=2 on segment 1 by the UPDATE statement.

At 1404, a computer system that executes transaction B locks the tuple in relation t1 with c1=4 on segment 1 by the UPDATE statement.

At 1406, the computer system that executes transaction B continues to try to update the tuple in relation t1 with c2=3 on segment 0 and c1=2 on segment 1 by the UPDATE statement. Since transaction A already holds the transaction lock on c2=3 on segment 0, transaction B has to wait on segment 0. Transaction C already holds transaction lock on c1=2 on segment 1, so transaction B has to wait on segment 1. Transaction B holds tuple lock on these two tuples from two segments.

At 1410, the computer system that executes transaction A tries to update the tuple in relation t1 with c1=2 on segment 1, this statement is blocked by transaction B because of the tuple lock. Transaction A waits for transaction B on segment 1 with the dotted waiting edge.

At 1412, a computer system that executes transaction D tries to update the tuple in relation t1 with c1=4 on segment 1 and it is blocked by transaction B.

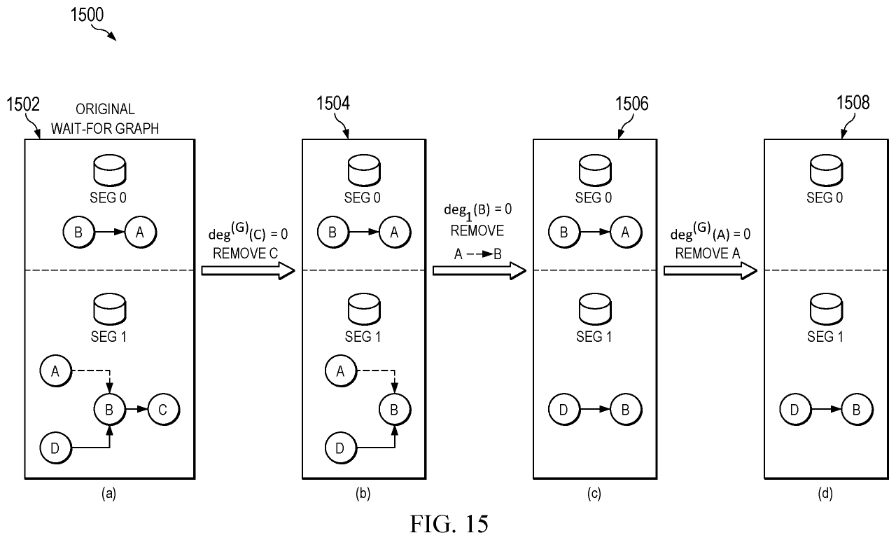

FIG. 15 illustrates an example process of GDD algorithm execution used to determine that the case illustrated in FIG. 14 has no global deadlock, in accordance with example implementations of this specification. This example process can be performed, for example, by an MPP database implemented on cloud environments 106 and 108 in FIG. 1.

At 1502, for the original global wait-for graph 1416 in FIG. 14, a computer system determines that deg^{(G)}(C)=0 since there is no edges starting from C anywhere. Therefore vertex C and all the edges to C can be removed based on the GDD algorithm.

At 1504, after removal of vertex C, there is no vertex with zero global out-degree. Next local out-degree is checked and the computer system determines that deg₁ (B)=0. Thus all the dotted edges to B can be removed based on the GDD algorithm.

At 1506, the computer system determines that deg^{(G)}(A)=0 for vertex A. Therefore vertex A and all edges to A can be removed based on the GDD algorithm.

At 1508, the computer system determines that deg(G)(B)=0 for vertex B. Therefore vertex B and all edges to B can be removed based on the GDD algorithm.

There are no edges left so we conclude global deadlock does not happen for this case.

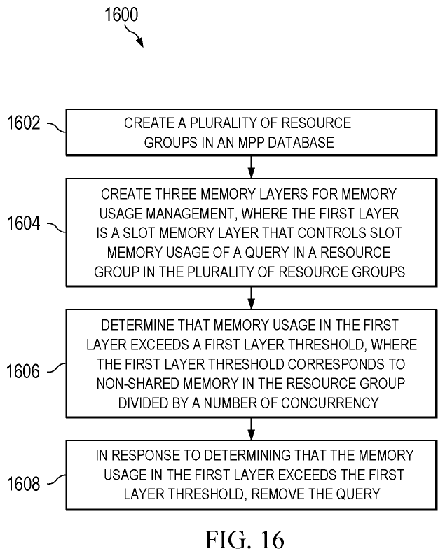

FIG. 16 illustrates an example of a method for memory isolation in an MPP database, in accordance with example implementations of this specification. It will be understood that method 1600 and related methods may be performed, for example, by any suitable system, environment, software, and hardware, or a combination of systems, environments, software, and hardware, as appropriate. For example, one or more of a client, a server, or other computing device can be used to execute method 1600 and related methods and obtain any data from the memory of a client, the server, or the other computing device. In some instances, the method 1600 and related methods are executed by one or more components of the system 100 described above with respect to FIG. 1. For example, the method 1600 and related methods can be executed by the cloud environment 106 of FIG. 1.

At 1602, an MPP database, for example, one implemented on cloud environments 106 and 108 in FIG. 1, creates a plurality of resource groups in an MPP database.

At 1604, the MPP database creates three memory layers for memory usage management, where the first layer is a slot memory layer that controls slot memory usage of a query in a resource group in the plurality of resource groups.

At 1606, the MPP database determines that memory usage in the first layer exceeds a first layer threshold, where the first layer threshold corresponds to non-shared memory in the resource group divided by a number of concurrency.

At 1608, in response to determining that the memory usage in the first layer exceeds the first layer threshold, the MPP database removes the query.

In some implementations, resource groups can be introduced in the MPP database to isolate the resources between different types of workloads or user groups. In some implementations, memory isolation can be implemented based on a memory management module that tracks memory usages in the MPP database kernel. In some implementations, the memory management module can be used to control memory usages among different resource groups. In some implementations, memory cannot be reclaimed immediately once allocated. In some implementations, when the memory usage of a resource group exceeds its limitation, queries in this group can be cancelled. In some implementations, a resource group can introduce three layers to manage the memory usage. In some implementations, the first layer can be enforced on slot memory, which controls the memory usage of a single query in a group. In some implementations, the slot memory can be calculated as the group non-shared memory divided by the number of concurrency. In some implementations, the second layer can be enforced on group shared memory, which can be used by the queries in the same resource group when the queries overuse the slot memory. In some implementations, group shared memory can be set for each resource group. In some implementations, the last layer can be enforced on global shared memory. In some implementations, the query cancel mechanism will not be triggered until all of the three layers cannot constrain the memory usage of the current running queries in the database.

In some implementations, resource groups can be created using the following syntax:
CREATE RESOURCE GROUP olap_group WITH (CONCURRENCY=10,
   MEMORY_LIMIT=35, MEMORY_SHARED_QUOTA=20,
   CPU_RATE_LIMIT=20);
CREATE RESOURCE GROUP oltp_group WITH (CONCURRENCY=50,
   MEMORY_LIMIT=15, MEMORY_SHARED_QUOTA=20,
   CPU_RATE_LIMIT=60);

In some implementations, to isolate the resources between different user groups, database administrator (DBA) can assign a resource group to a role using the ALTER ROLE or CREATE ROLE commands. For example:
CREATE ROLE dev1 RESOURCE GROUP olap_group;
ALTER ROLE dev1 RESOURCE GROUP oltp_group;

In some implementations, the resource group settings shown above can be applied to two resource groups: one resource group for analytical workloads, and the other resource group for transactional workloads. In some implementations, higher memory limit can be assigned to the analytical resource group to allow analytical queries to use more memory and to avoid spilling to disk excessively. In some implementations, the memory usage of transactional queries is low. In some implementations, concurrency is another parameter that can be set in the resource group settings. The concurrency parameter controls the maximum number of connections to the database. In some implementations, transactional workloads involve higher concurrency. On the other hand, in some implementations, the analytical workloads need a fine-grained control over concurrency. In some implementations, memory cannot be reclaimed immediately, because doing that can make the amount of memory used by each query small, which results in more frequent disk spills when the concurrency limit is set relatively high. In some implementations, there is a trade-off between the concurrency and performance.

In some implementations, the memory isolation can be performed in the following steps:

1. Define resource group and set the memory setting:
CREATE RESOURCE GROUP rg1(CONCURRENCY=10,
CPU_RATE_LIMIT=10, MEMORY_LIMIT=10,
MEMORY_SHARED_QUOTA=50, MEMORY_SPILL_RATIO=80)

2. Calculate slot memory:
TotalMemory*(MEMORY_LIMIT/100)*((100−MEMORY_SHARED_QUOTA)/100)/CONCURRENCY
where slot memory is the reserved memory for each transaction in this resource group. The number of concurrent transactions is controlled by CONCURRENCY parameter.

3. Calculate group shared memory:
TotalMemory*(MEMORY_LIMIT/100)*(MEMORY_SHARED_QUOTA/100)
where the group shared memory is the shared memory region for each resource group, when a transaction consumes more memory usage than the slot memory, it could further request memory from group shared region.

4. Calculate global memory:
TotalMemory−SumOfAllResourceGroupMemory.
where the sum of MEMORY_LIMIT of each resource group must be smaller than or equal to 100. If it is smaller than 100, the left memory is used as Global share memory.
When a transaction's memory usage exceeds the slot memory and group shared memory, it can still request memory from global shared region.

5. Calculate the operator memory:
Using parameter MEMORY_SPILL_RATIO, user is able to tune the operator memory. Operator memory is used to control the memory usage for each operator node. for example, Hash join, Sort, Agg etc. Operator memory determines the hash table size of Hash Join operator, and larger operator memory could ensure the in memory algorithm is used instead of on-disk algorithm which will generate spill files to disk.
TotalOperatorMemory=TotalMemory*(MEMORY_LIMIT/100)*(MEMORY_SPILL_RATIO/100)

6. Runaway mechanism:
When global shared region is nearly used up, calculate the resource group which uses the most of the global shared memory and select a memory top-consumer transaction and cancel it to release the memory.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method for global deadlock detection, comprising:
launching, by a massively parallel processing (MPP) database, a daemon on a coordinator segment in the MPP database, wherein the MPP database comprises the coordinator segment and a plurality of worker segments, wherein the MPP database is a hybrid database for both transactional workloads and analytical workloads, and wherein the transactional workloads are associated with transactions with each transaction modifying two or more entities in the MPP database;
collecting periodically by executing the daemon, a respective local wait-for graph for each of a plurality of segments in the MPP database, wherein each of the plurality of segments comprises the coordinator segment or a worker segment of the plurality of worker segments, wherein each collected local wait-for graph comprises a plurality of local vertices representing transactions associated with a respective segment and a plurality of local edges that go between the plurality of local vertices, and wherein each of the plurality of segments in the MPP database comprises transactions that are waiting for other transactions to commit or abort;
building a global wait-for graph comprising all collected local wait-for graphs, wherein the global wait-for graph comprises a plurality of vertices and a plurality of edges that go between the plurality of vertices;
determining that a global deadlock exists in the MPP database by utilizing the global wait-for graph, wherein the global deadlock exists when each transaction in the MPP database is waiting for another transaction in the MPP database to commit or abort; and
in response to determining that the global deadlock exists in the MPP database, breaking the global deadlock using one or more predefined policies.

2. The computer-implemented method according to claim 1, wherein
each vertex in the plurality of vertices comprises a respective transaction, wherein
each edge in the plurality of edges going from a corresponding lock-waiting vertex to a corresponding lock-holding vertex is an outgoing edge for the corresponding lock-waiting vertex, and is an incoming edge for the corresponding lock-holding vertex, wherein
the corresponding lock-waiting vertex is waiting for the corresponding lock-holding vertex to terminate, wherein
a corresponding local out-degree of each vertex in the global wait-for graph comprises a number of corresponding outgoing edges, and wherein
a corresponding local in-degree of each vertex in the global wait-for graph comprises a number of corresponding incoming edges.

3. The computer-implemented method according to claim 2, wherein determining that the global deadlock exists in the MPP database by utilizing the global wait-for graph comprises:
removing all incoming edges associated with all vertices that have no outgoing edges in the global wait-for graph;
removing all dotted edges in the plurality of edges that point to vertices with zero local out-degree, wherein a vertex has zero local out-degree if it has no outgoing edges in its local wait-for graph, and wherein a dotted edge in the plurality of edges corresponds to a lock-holding vertex that can release a corresponding lock without the lock-holding vertex being removed; and
in response to determining that a predetermined iteration stop condition is satisfied, wherein each iteration step comprises removing all incoming edges associated with all vertices that have no outgoing edges in the global wait-for graph and removing all dotted edges in the plurality of edges that point to vertices with zero local out-degree, determining that the global deadlock exists in the MPP database if there are one or more edges of the plurality of edges remaining in the global wait-for graph.

4. The computer-implemented method according to claim 1, wherein the one or more predefined policies comprise removing a vertex with the youngest transaction of all transactions in the plurality of vertices of the global wait-for graph.

5. The computer-implemented method according to claim 1, wherein the plurality of edges comprise a plurality of solid edges, wherein each solid edge of the plurality of solid edges can only be removed from the global wait-for graph when a corresponding lock-holding transaction ends.

6. The computer-implemented method according to claim 1, wherein the MPP database comprises a plurality of levels of lock modes, with relatively higher level of lock mode enabling relatively stricter granularity of concurrency control.

7. The computer-implemented method according to claim 1, wherein each transaction in the MPP database is created on the coordinator segment and distributed to a corresponding worker segment of the plurality of worker segments, and is assigned a local transaction identifier by the corresponding worker segment.

8. A non-transitory, computer-readable medium storing one or more instructions executable by a computer system to perform operations, the operations comprising:
launching, by a massively parallel processing (MPP) database, a daemon on a coordinator segment in the MPP database, wherein the MPP database comprises the coordinator segment and a plurality of worker segments, wherein the MPP database is a hybrid database for both transactional workloads and analytical workloads, and wherein the transactional workloads are associated with transactions with each transaction modifying two or more entities in the MPP database;
collecting periodically by executing the daemon, a respective local wait-for graph for each of a plurality of segments in the MPP database, wherein each of the plurality of segments comprises the coordinator segment or a worker segment of the plurality of worker segments, wherein each collected local wait-for graph comprises a plurality of local vertices representing transactions associated with a respective segment and a plurality of local edges that go between the plurality of local vertices, and wherein each of the plurality of segments in the MPP database comprises transactions that are waiting for other transactions to commit or abort;
building a global wait-for graph comprising all collected local wait-for graphs, wherein the global wait-for graph comprises a plurality of vertices and a plurality of edges that go between the plurality of vertices;
determining that a global deadlock exists in the MPP database by utilizing the global wait-for graph, wherein the global deadlock exists when each transaction in the MPP database is waiting for another transaction in the MPP database to commit or abort; and
in response to determining that the global deadlock exists in the MPP database, breaking the global deadlock using one or more predefined policies.

9. The non-transitory, computer-readable medium according to claim 8, wherein
each vertex in the plurality of vertices comprises a respective transaction, wherein
each edge in the plurality of edges going from a corresponding lock-waiting vertex to a corresponding lock-holding vertex is an outgoing edge for the corresponding lock-waiting vertex, and is an incoming edge for the corresponding lock-holding vertex, wherein
the corresponding lock-waiting vertex is waiting for the corresponding lock-holding vertex to terminate, wherein
a corresponding local out-degree of each vertex in the global wait-for graph comprises a number of corresponding outgoing edges, and wherein
a corresponding local in-degree of each vertex in the global wait-for graph comprises a number of corresponding incoming edges.

10. The non-transitory, computer-readable medium according to claim 9, wherein determining that the global deadlock exists in the MPP database by utilizing the global wait-for graph comprises:
removing all incoming edges associated with all vertices that have no outgoing edges in the global wait-for graph;
removing all dotted edges in the plurality of edges that point to vertices with zero local out-degree, wherein a vertex has zero local out-degree if it has no outgoing edges in its local wait-for graph, and wherein a dotted edge in the plurality of edges corresponds to a lock-holding vertex that can release a corresponding lock without the lock-holding vertex being removed; and
in response to determining that a predetermined iteration stop condition is satisfied, wherein each iteration step comprises removing all incoming edges associated with all vertices that have no outgoing edges in the global wait-for graph and removing all dotted edges in the plurality of edges that point to vertices with zero local out-degree, determining that the global deadlock exists in the MPP database if there are one or more edges of the plurality of edges remaining in the global wait-for graph.

11. The non-transitory, computer-readable medium according to claim 8, wherein the one or more predefined policies comprise removing a vertex with the youngest transaction of all transactions in the plurality of vertices of the global wait-for graph.

12. The non-transitory, computer-readable medium according to claim 8, wherein the plurality of edges comprise a plurality of solid edges, wherein each solid edge of the plurality of solid edges can only be removed from the global wait-for graph when a corresponding lock-holding transaction ends.

13. The non-transitory, computer-readable medium according to claim 8, wherein the MPP database comprises a plurality of levels of lock modes, with relatively higher level of lock mode enabling relatively stricter granularity of concurrency control.

14. The non-transitory, computer-readable medium according to claim 8, wherein each transaction in the MPP database is created on the coordinator segment and distributed to a corresponding worker segment of the plurality of worker segments, and is assigned a local transaction identifier by the corresponding worker segment.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, the one or more operations comprising:
launching, by a massively parallel processing (MPP) database, a daemon on a coordinator segment in the MPP database, wherein the MPP database comprises the coordinator segment and a plurality of worker segments, wherein the MPP database is a hybrid database for both transactional workloads and analytical workloads, and wherein the transactional workloads are associated with transactions with each transaction modifying two or more entities in the MPP database;
collecting periodically by executing the daemon, a respective local wait-for graph for each of a plurality of segments in the MPP database, wherein each of the plurality of segments comprises the coordinator segment or a worker segment of the plurality of worker segments, wherein each collected local wait-for graph comprises a plurality of local vertices representing transactions associated with a respective segment and a plurality of local edges that go between the plurality of local vertices, and wherein each of the plurality of segments in the MPP database comprises transactions that are waiting for other transactions to commit or abort;
building a global wait-for graph comprising all collected local wait-for graphs, wherein the global wait-for graph comprises a plurality of vertices and a plurality of edges that go between the plurality of vertices;
determining that a global deadlock exists in the MPP database by utilizing the global wait-for graph, wherein the global deadlock exists when each transaction in the MPP database is waiting for another transaction in the MPP database to commit or abort; and
in response to determining that the global deadlock exists in the MPP database, breaking the global deadlock using one or more predefined policies.

16. The computer-implemented system according to claim 15, wherein
each vertex in the plurality of vertices comprises a respective transaction, wherein
each edge in the plurality of edges going from a corresponding lock-waiting vertex to a corresponding lock-holding vertex is an outgoing edge for the corresponding lock-waiting vertex, and is an incoming edge for the corresponding lock-holding vertex, wherein
the corresponding lock-waiting vertex is waiting for the corresponding lock-holding vertex to terminate, wherein
a corresponding local out-degree of each vertex in the global wait-for graph comprises a number of corresponding outgoing edges, and wherein
a corresponding local in-degree of each vertex in the global wait-for graph comprises a number of corresponding incoming edges.

17. The computer-implemented system according to claim 16, wherein determining that the global deadlock exists in the MPP database by utilizing the global wait-for graph comprises:
removing all incoming edges associated with all vertices that have no outgoing edges in the global wait-for graph;
removing all dotted edges in the plurality of edges that point to vertices with zero local out-degree, wherein a vertex has zero local out-degree if it has no outgoing edges in its local wait-for graph, and wherein a dotted edge in the plurality of edges corresponds to a lock-holding vertex that can release a corresponding lock without the lock-holding vertex being removed; and
in response to determining that a predetermined iteration stop condition is satisfied, wherein each iteration step comprises removing all incoming edges associated with all vertices that have no outgoing edges in the global wait-for graph and removing all dotted edges in the plurality of edges that point to vertices with zero local out-degree, determining that the global deadlock exists in the MPP database if there are one or more edges of the plurality of edges remaining in the global wait-for graph.

18. The computer-implemented system according to claim 15, wherein the one or more predefined policies comprise removing a vertex with the youngest transaction of all transactions in the plurality of vertices of the global wait-for graph.

19. The computer-implemented system according to claim 15, wherein the plurality of edges comprise a plurality of solid edges, wherein each solid edge of the plurality of solid edges can only be removed from the global wait-for graph when a corresponding lock-holding transaction ends.

20. The computer-implemented system according to claim 15, wherein each transaction in the MPP database is created on the coordinator segment and distributed to a corresponding worker segment of the plurality of worker segments, and is assigned a local transaction identifier by the corresponding worker segment.
